(19) United States
(12) Patent Application Publication
(10) Pub. No.: US 2012/0118988 A1
(43) Pub. Date: May 17, 2012

(54) HEATING SYSTEM FOR FUEL CELL VEHICLE

(75) Inventors: Seung Yong Lee, Yongin (KR); Chi Myung Kim, Yongin (KR); Eung Young Kim, Anyang (KR); Gi Young Nam, Yongin (KR); Sung Wook Na, Yongin (KR); Hark Koo Kim, Yongin (KR); Kwang Ok Han, Hwaseong (KR); Kyoon Soo Lim, Suwon (KR); Yong Sun Park, Yongin (KR)

(73) Assignees: KIA MOTORS CORPORATION, Seoul (KR); HYUNDAI MOTOR COMPANY, Seoul (KR)

(21) Appl. No.: 13/153,727

(22) Filed: Jun. 6, 2011

(30) Foreign Application Priority Data
Nov. 15, 2010 (KR) 10-2010-0113124

(51) Int. Cl. B60L 1/02; B60L 1/12; B60H 1/22

(52) U.S. Cl. 237/12.3 R; 237/12.3 B; 237/28; 165/202

(57) ABSTRACT

The present invention provides a heating system for a fuel cell vehicle, in which an additional heating source is used together with an electric heater to lower power consumption and increase fuel efficiency of prior systems. For this purpose the present invention provides a heating system for a fuel cell vehicle, the heating system including: an electric heater for heating air blown by a blower fan and supplied to the interior of the vehicle; and a heater core provided in a coolant line, through which coolant for cooling a fuel cell stack is circulated, and is used for heating the air, blown by the blower fan and supplied to the interior of the vehicle, by heat transfer between the coolant and the air, wherein the heater core is provided at the downstream side of the fuel cell stack in a coolant circulation path such that the air is heated by waste heat of the coolant discharged from the fuel cell stack.

### CROSS-REFERENCE TO RELATED APPLICATION

This application claims under 35 U.S.C. §119(a) the benefit of Korean Patent Application No. 10-2010-0113124 filed Nov. 15, 2010, the entire contents of which are incorporated herein by reference.

### BACKGROUND

(a) Technical Field

The present invention relates to a heating system for a fuel cell vehicle. More particularly, it relates to a heating system for a fuel cell vehicle, in which an additional to heating source is used together with a typical electric heater to provide heat to an interior of the fuel cell vehicle.

(b) Background Art

Internal combustion engines using fossil fuels contribute to environmental pollution due to exhaust gases, global warming due to carbon dioxide emissions, respiratory diseases due to increased ozone, etc. Moreover, since the amount of fossil fuels left on earth is limited, they will be exhausted in the near future.

In an effort to provide alternatives to fossil fuels, various types of electric vehicles, such as a pure electric vehicle (EV) driven by a drive motor, a hybrid electric vehicle (HEV) driven by an engine and a drive motor, and a fuel cell electric vehicle (FCEV) driven by a drive motor using electricity generated by a fuel cell, to name a few, have been developed.

Conventionally, electric heaters may be used to heat the interior of the electric vehicle. This is unlike an internal combustion engine vehicle which is equipped with a heater that uses the hot water heated by waste heat of the engine.

In particular, the pure electric vehicle (which uses only an electric heater), the hybrid electric vehicle (which uses both engine waste heat and an electric heater), and the fuel cell vehicle (which uses only an electric heater) either are not equipped with an engine or have a mode in which the engine is stopped (e.g., the HEV), and thus the electric heater is necessarily required to heat the interior of the vehicle continuously.

Typically, positive temperature (PTC) heaters are widely used as a heating source in a diesel vehicle together with the waste heat of the engine. Since the PTC heater can rapidly generate heat, the interior temperature can be easily increased and the heating can be easily controlled by simple control logic.

However, when only the PTC heater (with a maximum capacity of 5 kW, for example) is used for the heating in environmentally-friendly vehicles such as pure electric vehicles, fuel cell vehicles, etc., consumes the power of a battery or the fuel cell to drive the PTC heater, and thus the driving distance of the vehicle is reduced.

Even in a fuel cell vehicle, the PTC heater is operated by the electricity generated in the fuel cell of the vehicle, i.e., the electricity generated by the fuel cell or the electricity of the battery charged by the power generation of the fuel cell. However, as the fuel cell vehicle is not equipped with an engine, only a high capacity PTC heater can be used, which increases the power consumption for heating the interior of the vehicle (or increases the amount of hydrogen used as a fuel), thereby reducing fuel efficiency.

Moreover, in a conventional heating system using only a high capacity PTC heater, the interior temperature can be rapidly increased, but the maximum heating performance is insufficient. Especially, when the vehicle-running wind is used as air for heating when a blower fan is turned off during running in the winter when the ambient temperature is lower. In this instance, the surface temperature of the PTC heater is rapidly reduced because of heat transfer with the cold air outside even when the PTC heater is operated, and thus cold air is introduced into the interior of the vehicle.

Another example of the electric heater is a heat pump system using CO₂. Disadvantageously, however, to apply the heat pump system, the structure of the vehicle must be changed significantly, which is problematic in terms of cost and mass production. Moreover, high pressure conditions required to operate the system may cause a safety problem.

FIG. 1 shows an example in which a PTC heater is controlled in three stages (e.g., 1 kW, 3 kW, and 5 kW) according to a change in heating load required to heat the interior of the vehicle in winter. That is, the amount of heat generated by the PTC heater varies according to the variation in the heating load to maintain the interior temperature within a predetermined range.

For example, if the interior temperature does not fall within the predetermined range during operation of the heating system, the amount of heat generated by the PTC heater (e.g., with a maximum capacity of 5 kW) is increased from about 1 kW to 5 kW step by step as shown in the figure.

As such, only the PTC heater is being used to heat the interior of the fuel cell vehicle and, in this case, the fuel efficiency is significantly reduced by the power consumption of the PTC heater.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention relates to a heating system for a fuel cell vehicle, in which an additional heating source is used together with a typical electric heater to reduce high power consumption and increase fuel while at the same time providing more efficient heating of an interior of a vehicle.

In one aspect, the present invention provides a heating system for a fuel cell vehicle, the heating system includes an electric heater for heating air blown by a blower fan and supplied to the interior of the vehicle; and a heater core provided in a coolant line, through which coolant for cooling a fuel cell stack is circulated. The heated coolant is used to heat the air, blown by the blower fan and supplied to the interior of the vehicle, by heat transfer between the coolant and the air. More specifically, the heater core is provided at the downstream side of the fuel cell stack in a coolant circulation path such that the air may be heated by waste heat of the coolant discharged from the fuel cell stack.

In some embodiments, the heater core may be disposed and provided at the upstream side of a demineralizer in the coolant circulation path such that the coolant, whose heat is transferred to the heater core, passes through the demineralizer.

In another embodiment, the heater core and the demineralizer may be provided in a main coolant line between the fuel cell stack and a three-way valve or in a bypass line branched from the main coolant line.

In still another embodiment, the heater core may be disposed and provided at the to downstream side of a coolant pump and a cathode oxygen depletion (COD) such that the coolant sequentially passing through the coolant pump and the COD passes through the heater core.

In yet another embodiment, the heating system may further include a bypass line branched from the main coolant line between the upstream and downstream sides of the coolant pump and the COD, so that the heater core and the demineralizer may be disposed and provided in the bypass line connected between the upstream and downstream sides.

In still yet another embodiment, the heating system may even further include a coolant line, in which a radiator is provided, and a bypass line, provided such that the coolant does not pass through the radiator. In this embodiment, the coolant line and the bypass line are branched from an outlet side of the COD such that the coolant passing through the coolant pump and the COD passes through the heater core, without going through the radiator.

In a further embodiment, the electric heater and the heater core may be arranged adjacent to each other in an air-conditioning duct, to which the air suctioned during operation of the blower fan is supplied, and a damper door for selectively preventing the suctioned air from flowing into the heater core is disposed and provided in front of the heater core such that only the electric heater is used alone.

Other aspects and preferred embodiments of the invention are discussed below.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram showing an example in which a PTC heater is controlled according to a change in heating load required to heat the interior of a fuel cell vehicle in winter.

FIG. 2 is a schematic diagram showing an exemplary configuration of a heating system for a fuel cell vehicle in accordance with an exemplary embodiment of the present invention.

FIGS. 3 and 4 are diagrams showing the control flow of a heating system for a fuel cell vehicle in accordance with an exemplary embodiment of the present invention.

Reference numerals set forth in the Drawings includes reference to the following elements as further discussed below:

10: fuel cell stack

21: radiator

22: coolant line

23: bypass line

24: a three-way valve

25: coolant pump

26: bypass line

31: COD

41: electric heater (PTC heater)

42: a heater core

43: blower fan

44: damper door

45: demineralizer

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The present invention provides a heating system 20 for a fuel cell vehicle, in which a heater core is used as an additional heating source together with a typical electric heater in a fuel cell vehicle.

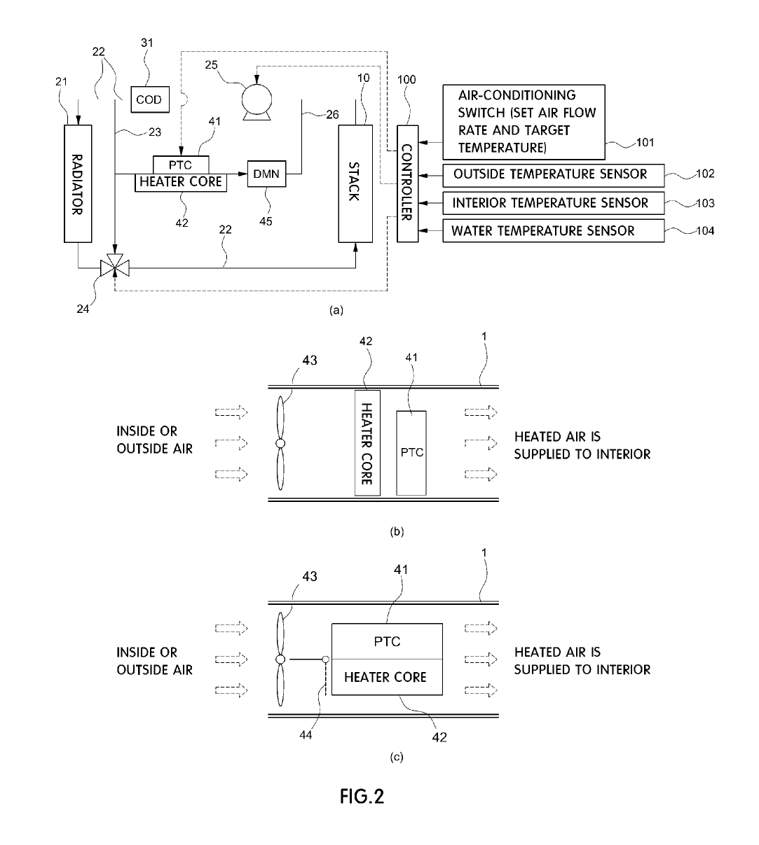

FIG. 2 is a schematic diagram showing the configuration of a heating system for a fuel cell vehicle in accordance with an embodiment of the present invention, in which coolant passes through heater core 42 to increase the temperature of air via heat transfer between the air and the coolant, is additionally provided.

Referring to FIG. 2, the heater core 42 according to the present invention is added as a heating source of the fuel cell vehicle in combination with an electric heater (e.g., a PTC to heater) 41. Moreover, a cooling system for removing reaction heat from a fuel cell stack 10 to the outside of the system and controlling the operating temperature of the fuel cell stack 10 is shown as well.

The heating system 20, also includes, a cathode oxygen depletion (COD) 31 for removing residual oxygen from the fuel cell stack 10 and a demineralizer (DMN) 45 for removing ionic substances contained in the coolant.

The illustrative cooling system is configured to maintain the fuel cell stack 10 within an optimum operating temperature range. More specifically, the cooling system is made up of a radiator 21, coolant line 22, bypass line 23, three-way valve 24, and a coolant pump 25. The radiator 21 radiates heat of the coolant, which is received from the coolant line, to the outside. Illustratively, the coolant line 22 is connected between the fuel cell stack 10 and the radiator 21 so that the coolant is circulated therethrough. The three-way valve 24 is disposed on the downstream side of the radiator 21 and is in fluid communication with both an outlet line of the radiator 21 and the bypass line 23. The bypass line is fluidly connected to the coolant line 22 and the three-valve 24 so that when the coolant passes through the bypass line the coolant does not pass through the radiator 21. Furthermore, the coolant pump 25 is configured to pump and circulate the coolant through the coolant line 22.

More particularly, the bypass line 23 is a coolant line branched from the coolant line 22 between the upstream and downstream sides of the radiator 21 to allow the coolant not to pass through the radiator 21.

In some embodiments of the present invention, the three-way valve 24 may be an electronic valve, in which a valve actuator is driven by a control signal applied from a controller 100 to switch the coolant flow so that the coolant may be selectively passed through the radiator 21.

More specifically, the three-way valve 24 may be an electronic valve, in which a step motor is used as the valve actuator so that the opening angle of the electronic valve is controlled by a control signal applied from the controller 100 to control the opening degrees of both passages (including a radiator passage and a bypass passage). In this case, the amount of coolant passing through the radiator 21 and the amount of coolant bypassed can be appropriately distributed.

The coolant pump 25 circulates the coolant through the coolant line 22 to maintain the temperature of the coolant at a constant level. When the controller 100 controls the rotational speed of the coolant pump 25 together with an opening angle of the three-way valve 24, the amount of coolant passing through the heater core 42 can be actively controlled, and thus the amount of heat generated by the heater core 42 and the amount of heat supplied to the interior of the vehicle can be controlled.

For example, the rotational speed of the coolant pump 25 and the opening angle of the three-way valve 24 can be controlled in view of the coolant temperature and the operation of the PTC heater which are detected by a water temperature sensor 104 (e.g., a temperature sensor at a coolant outlet of the fuel cell stack), an interior temperature detected by an interior temperature sensor 103, and a predetermined temperature (e.g., a target air-conditioning temperature) set by e.g., a driver using an air-conditioning switch 101, during operation of a to blower fan 43. By doing so, the amount of heat supplied by the heater core 42 can be controlled.

The COD 31 provided in the coolant line 22 may be connected to both ends of the fuel cell stack 10 to consume the power generated by the reaction of hydrogen and oxygen to generate heat energy during shutdown of the fuel cell, thus removing oxygen from the fuel cell stack 10. As a result, it is possible to prevent a reduction in durability of the fuel cell stack due to corrosion of catalyst-supported carbon.

The COD 31 mainly functions to consume the residual fuel in the fuel cell stack 10. In particular the COD 31 includes a heating device having a plurality of heater rods for load consumption provided in a housing such that the coolant passes through the inside of the housing and the periphery of the heater rods. Therefore, the COD 31 may be configured as an integrated heater which rapidly heats the coolant (i.e., rapidly increases the temperature of the fuel cell stack to a range where the efficiency is high) such that the power generation of the fuel cell stack is facilitated during initial start-up when the temperature of the fuel cell stack is low and the power consumption of the fuel cell stack should be maximized.

This integrated heater has a structure in which the heater rods are inserted into the housing such that the coolant flowing into the housing passes through the periphery of the heater rods and is discharged to the outside of the housing. Thus, the heater rods function as resistors for load consumption and as heaters for rapidly heating the coolant.

The demineralizer 45 removes ionic substances contained in the coolant to maintain the ion conductivity of the coolant below a predetermined level, thus preventing the current of the fuel cell stack from leaking through the coolant. More particularly, the demineralizer 45 may be provided in a main coolant line between the fuel cell stack 10 and the three-way valve 24 or provided in a bypass line branched from the main coolant line between the fuel cell stack 10 and the three-way valve 24, e.g., the bypass line 26 branched from the main coolant line 22 between the upstream and downstream sides of the coolant pump 25.

The heater core 42 also heats the air (i.e., the outside or inside air) blown by the blower fan 43 and passing therethrough, like the electric heater (or PTC) 41. When the air suctioned during the operation of the blower fan 43 is introduced into an air-conditioning duct 1 and supplied to the electric heater 41 and the heater core 42, the air is heated while passing through the electric heater 41 and the heater core 42, flows through a duct connected to the interior of the vehicle, and is then supplied to the interior of the vehicle through an outlet of the duct.

In the heater core 42, the coolant heated as a result of passing through the fuel cell stack 10 transfers heat/energy to the air passing through the periphery of cooling fins of the heater core 42, while passing through tubes of the heater core 42.

As shown in (b) of FIG. 2, the heater core 42 and the electric heater 41 may be arranged at front and rear sides, respectively. For example, the heater core 42 may be disposed in front of the electric heater 41 and the electric heater 41 is disposed in the rear of the heater core 42 to allow the air blown by the blower fan 43 to sequentially pass through the heater core 42 and then to the electric heater 41.

In this case, the heater core 42 is continuously supplied heat (i.e., coolant waste heat) to during operation of the fuel cell stack 10, and thus the air primarily heated by the heater core 42 can be additionally heated by the electric heater 41. Advantageously, the present invention may also be used even when the air used for heating is provided by vehicle running wind, for example where the blower fan 43 is turned off during running in winter when the ambient temperature is low. As a result, it is possible to prevent the cold air from being introduced into the interior of the vehicle to a greater degree.

Alternatively, as shown in (c) of FIG. 2, the heater core 42 and the electric heater 41 may be arranged adjacent to each other such that the air supplied by the blower fan 43 passes therethrough.

In this case, a damper door 44 may be provided in front of the heater core 42, to selectively block a passage in the front of the heater core 42 so that the air blown by the blower fan 43 can pass only through the electric heater 41.

The operation of the damper door 44 is controlled by the controller 100 so that the air is not supplied to the heater core 42 when only the PTC heater 41 is used as the heating source or when the temperature of the coolant is to be rapidly increased.

When the damper door 44 blocks the passage at the heater core 42, the air flow to the heater core 42 is blocked during operation of the blower fan 43 and the heat transfer between the coolant and the air is not performed in the heater core 42. Thus, the temperature of the coolant can be increased more rapidly.

As stated above, the electric heater 41 may be embodied as a PTC heater. As such, the heater core 42 used as an additional heating source in the present invention is provided at a position where the coolant discharged from the fuel cell stack 10 passes, e.g., at the downstream side of the fuel cell stack 10 in the coolant circulation path, so that the temperature of the air for heating the interior of the vehicle (e.g., the air blown by the blower fan and supplied to the interior of the vehicle) is increased using waste heat of the coolant discharged from the fuel cell stack 10.

That is, the heater core 42 is provided at the downstream side of the fuel cell stack 10 so that the waste heat of the coolant may be used to heat the interior of the vehicle in addition to the electric heater 41. Therefore, the coolant heated while the fuel cell stack 10 is cooled can be used as a heating medium of the heater core 42.

Alternatively, the heater core 42 may be also be disposed and provided in the bypass line 26 where the demineralizer 45 may also be disposed and provided.

For example, the bypass line 26 may be branched from the main coolant line 22 between the upstream and downstream sides of the coolant pump 25 and the COD 31, and the heater core 42 and the demineralizer 45 may be provided in the bypass line 26 connected between the upstream and downstream sides.

In some embodiments of the present invention, the heater core 42 may be provided on the upstream side of the demineralizer 45 in the coolant circulation path. The reason for this is that the demineralization performance of ion-transfer resin filled in the demineralizer 45 is reduced at higher temperatures. Therefore, the demineralizer 45 may be provided at the rear of the heater core 42 such that the coolant whose heat is transferred to the air for to heating the interior of the vehicle, i.e., the coolant cooled by the heat transfer with the air in the heater core 42, is introduced into the demineralizer 45.

Moreover, the COD 31 may also be provided at the downstream side of the coolant pump 25, and the heater core 42 may be provided at the downstream side of the coolant pump 25 and the COD 31 in the coolant circulation path such that the coolant sequentially passing through the coolant pump 25 and the COD 31 passes through the heater core 42.

As will be described later, the COD 31 converts electrical energy generated by the fuel cell stack 10 into heat to increase the temperature of the coolant. The coolant heated by the COD 31 can then be transferred to the heater core 42 during operation of the heating system (e.g., when the heating load is required) and when the fuel cell is in an idle stop mode. Therefore, the COD 31 may be located at the upstream side of the heater core 42 in the coolant circulation path.

Moreover, the coolant heated by the COD 31 may be cooled by the radiator 21 when the operation of the heating system is stopped in summer, and thus the coolant passing through the COD 31 should selectively passes through the radiator 21.

Therefore, the coolant line 22, in which the radiator 21 is provided, and the bypass line 23, provided such that the coolant does not pass through the radiator 21, may be branched from the outlet side of the COD 31 (i.e., at the downstream side in the coolant circulation path) so that the coolant passing through the COD 31 passes through the radiator 21 or does not pass through the radiator 21.

As a result, the high temperature coolant discharged from the fuel cell stack 10 sequentially passes through the coolant pump 25, the COD 31, the heater core 42, and the demineralizer 45. Alternatively, the coolant passing through the COD 31 may also pass through the radiator 21 to be cooled according to the opening degree of the three-way valve 24.

In this structure, the high temperature coolant discharged from the coolant outlet of the fuel cell stack 10 can be further heated by the shaft horse power of the coolant pump 25 and then introduced into the heater core 42. In this case, the coolant does not pass through the radiator 21, thus the three-way valve 24 cuts off the coolant passage at the radiator 21 so that the coolant is not circulated through the radiator 21 during the heating of the interior.

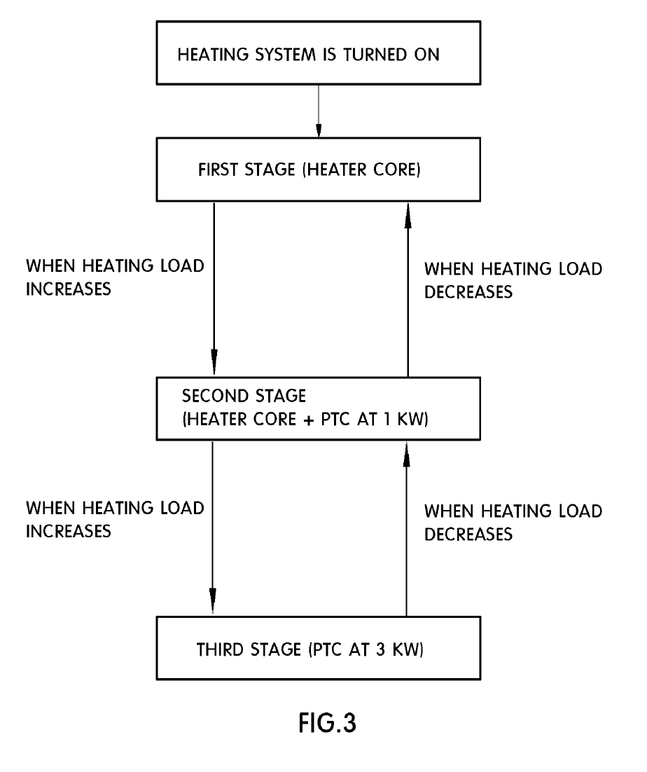

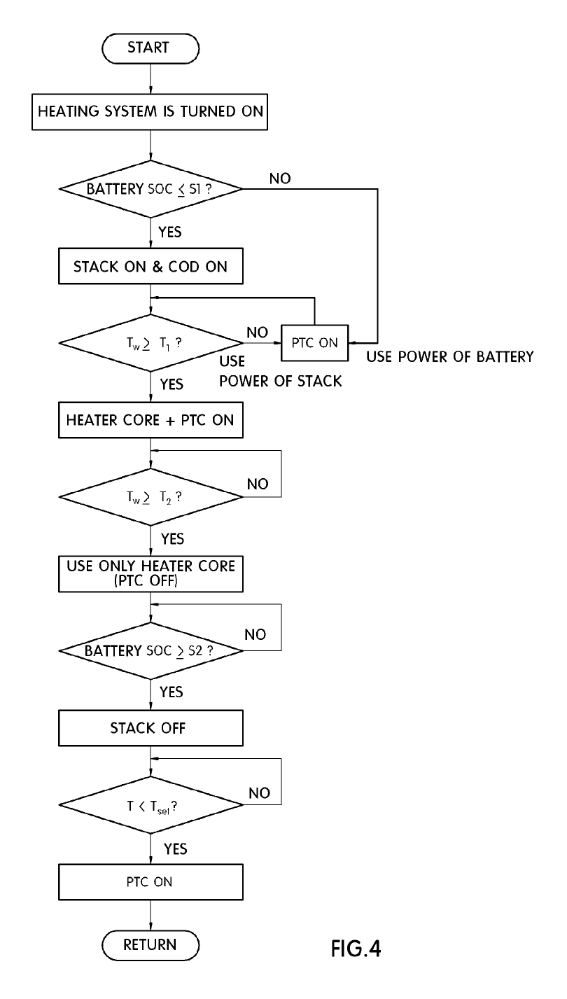

Meanwhile, FIGS. 3 and 4 are diagrams showing the control flow of the above-described heating system in accordance with the present invention. First, as shown in FIG. 3, when the vehicle is running and the fuel cell stack normally operates, the heating system can be controlled in any one of three stages. In the first stage, only the heater core 42 is operated. In the second stage, both the heater core 42 and the electric heater 41 are operated together. And in the third stage, only the electric heater 41 is operated. Selection of each stage is determined according to a change in heating load required to heat the interior of the vehicle.

Here, when the heating load is at the lowest level, the heating system is controlled in the first stage (where only the heater core is used), and as the heating load is increased, the heating system is controlled in the second stage (e.g., where both the heater core and the electric heater at e.g., about 1 kW are used) or in the third stage (where only the PTC heater at, e.g., about 3 kW is used. Moreover, as the heating load is reduced, the heating system can be controlled in the order from the third to first stages.

However, the output of the electric heater 41 in the third stage is increased compared to that in the second stage such that the amount of heat generated by the electric heater 41 is increased in the third stage (e.g., to about 3 kW) when only the electric heater 41 is used, compared to the second stage (1 kW) where the heater core 42 is used as an additional heating source.

In the third stage where only the electric heater 41 is used, the controller 100 controls the damper door 44 shown in FIG. 2 to be disposed at a position (shown by a dotted line in FIG. 2) to block the passage at the heater core 42 such that the air blown by the blower fan 43 can pass only through the electric heater 41.

Moreover, as mentioned above, when the heater core 42 is used during operation of the blower fan 43, the rotational speed of the coolant pump 25 and the opening angle of the three-way valve 24 can be controlled in view of the coolant temperature and the operation of the electric heater which are detected by the water temperature sensor 104, the interior temperature detected by the interior temperature sensor 103, a predetermined temperature set by a driver using the air-conditioning switch 101, etc., and thus the amount of heat supplied by the heater core 42 can be controlled accordingly.

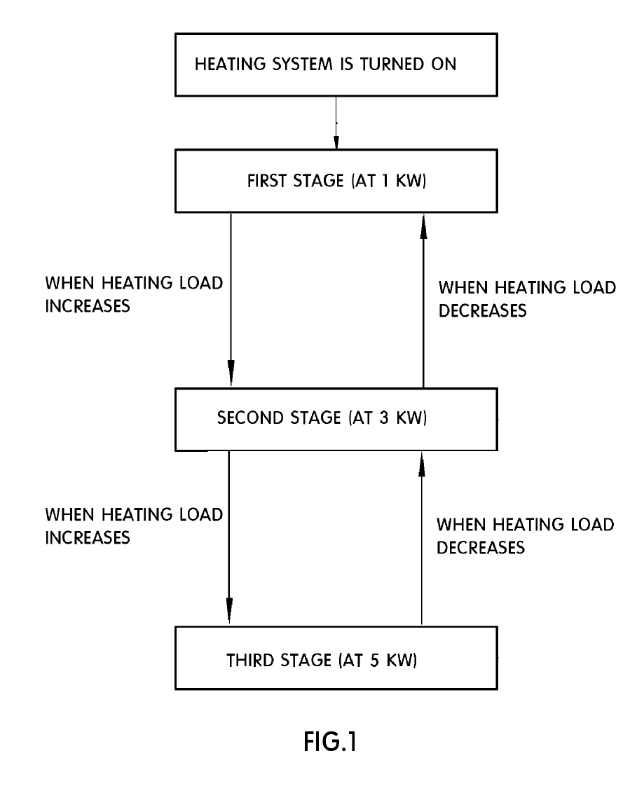

As such, the heater core 42 is used as an additional heating source in the heating system of the present invention, and thus the electric heater 41 can be operated at about 1 kW in the second stage and at about 3 kW in the third stage. Therefore, about 2 kW of power, which is insufficient compared to that of FIG. 1, can be covered by the waste heat of the coolant using the heater core 42, and thus the capacity of the electric heater 41 can be relatively reduced.

That is, an electric heater with a capacity of about 3 kW can be used instead of an electric heater with a maximum capacity of about 5 kW. Moreover, the insufficient heat load of the electric heaters discussed in the prior art is covered by the waste heat of the coolant, and thus the output and the power consumption of the electric heater can be reduced, thereby improving fuel efficiency.

Next, an idle stop mode will be described with reference to FIG. 4.

In the following description, the main control unit of the COD and the fuel cell stack may be a fuel cell system controller (not shown), and the controller, denoted by reference numeral 100 in FIG. 2, may be an air-conditioning controller. Moreover, the control process of the present invention may be performed under the cooperative control of, e.g., the fuel cell system controller, the air-conditioning controller, a battery management system BMS [e.g., for transmitting the state of charge (SOC) of a battery, not shown].

First, in an idle stop state, after the heating system is turned on, when a heating load is required because the interior temperature T detected by the interior temperature sensor 103 is lower than a predetermined temperature Tₛₑₜ set by a driver using the air-conditioning switch 101, the air-conditioning controller 100 first checks the SOC of the battery (not shown), which is transmitted from the battery management system.

In this embodiment of the present invention, if the SOC of the battery is above a predetermined lower limit S1, the electric heater 41 may be operated by the power of the battery.

On the contrary, if the SOC of the battery is lower than the lower limit S1, the electric heater 41 is not able to be operated by just the power of the battery, and thus reactant gases are supplied to the fuel cell stack 10 to initiate the operation of the fuel cell stack 10. Next, the COD 31 is operated to increase the temperature of the coolant to prevent local deterioration of the fuel cell stack 10.

Here, if the coolant temperature T_{w} detected by the water temperature sensor 104 (i.e., the temperature sensor at the coolant outlet of the fuel cell stack) is below a predetermined temperature at which the fuel cell stack 10 does not reach a normal operating temperature, e.g., below a maximum temperature T1 which can be increased by the COD 31 (as a predetermined temperature, 58° C., for example), the electric heater 41 may be operated by the power generated by the fuel cell stack 10. In this case, the PTC heater 41 may just be used to heat the interior of the vehicle, and the output of the electric heater 41 is appropriately controlled to a maximum of about 3 kW according to the heating load.

Subsequently, if the coolant temperature T_{w} is increased above the maximum temperature T1 by the heat of the fuel cell stack 10 and the COD 31, the heater core 42 may be used together with the electric heater 41 to heat the interior of the vehicle and, even in this case, the output of the electric heater 41 may be appropriately controlled according to the vehicle's heating load requirement.

Thereafter, if the coolant temperature T_{w} is increased above a normal operating temperature T2 of the fuel cell stack 10 (as a predetermined temperature, 65° C., for example), the electric heater 41 may be turned off, and the heater core 42 may just be is used alone to heat the interior of the vehicle.

Accordingly, during the use of the heater core 42, the rotational speed of the coolant pump 25 and the opening angle of the three-way valve 24 can be controlled in view of the coolant temperature T_{w}, the operation of the electric heater, the interior temperature T, and the predetermined temperature Tₛₑₜ, and thus the amount of heat supplied by the heater core 42 can be controlled.

Subsequently, if the SOC of the battery, which is charged by the power generated by the fuel cell stack 10, is above a predetermined reference value S2 (e.g., the battery in a full charge state), the operation of the fuel cell stack 10 may be turned off and, when the interior temperature T is lower than the predetermined temperature Tₛₑₜ, the electric heater 41 may be additionally operated by the power of the battery.

The above-described control process is applied even during initial start-up of the fuel cell. If the heating load is required after an operation of the fuel cell stack 10 is initiated, the SOC of the battery is checked and, if the SOC of the battery is above the lower limit S1, the electric heater 41 may be operated by the power of the battery alone. Otherwise, if the SOC of the battery is below the lower limit S1, the electric heater 41 may be operated by the power of the fuel cell stack 10.

Even in this case, if the coolant temperature T_{w} is less than the maximum temperature T1 during operation of the COD 31, just the electric heater 41 alone can be used to heat the interior of the vehicle, and the output of the electric heater 41 is appropriately controlled to a maximum of about 3 kW according to the heating load.

Then, if the coolant temperature T_{w} is continuously increased above the maximum temperature T1 by the heat of the fuel cell stack 10 and the COD 31, the heater core 42 may be used together with the electric heater 41 to heat the interior of the vehicle, and the output of the electric heater 41 is appropriately controlled according to the heating load.

Moreover, if the coolant temperature T_{w} is increased above the normal operating temperature T2 of the fuel cell stack 10, the electric heater 41 may be turned off, and just the heater core 42 alone may be used to heat the interior of the vehicle.

Even in this case, the rotational speed of the coolant pump 25 and the opening angle of the three-way valve 24 can be controlled in view of the coolant temperature T_{w}, the operation of the electric heater, the interior temperature T, and the predetermined temperature Tₛₑₜ, and thus the amount of heat supplied by the heater core 42 can be controlled.

Advantageously, the heater core is used as an additional heating source together with the electric heater to increase the temperature of the air for heating the interior of the vehicle by using the waste heat of the coolant discharged from the fuel cell stack. Thus, it is possible to eliminate the need of excessive power consumption due to the sole use of the electric heater and improve the fuel efficiency of the fuel cell vehicle.

Furthermore, the heating system of the present invention can be implemented by providing the heater core for using the waste heat of the coolant in the coolant line and adding control logic to its operation. Thus, it is possible to minimize the change in the system and its cost.

Moreover, since both the electric heater and the heater core are used together, it is possible to rapidly increase the interior temperature and, at the same time, provide excellent heating performance in fuel cell vehicles.

Furthermore, it is possible to implement various control logics with the use of the COD, which can rapidly increase the temperature of the coolant, and the existing electric heater. That is, it is possible to control the rotational speed of the coolant pump and the opening degree of the three-way valve, and thus it is possible to optimally control the amount of coolant and the amount of heat supplied by the heater core, thereby maximizing the heating efficiency.

More specifically, the present invention can more precisely control the amount of heat required to rapidly increase the interior temperature to a target temperature desired by a driver, thereby improving the air-conditioning efficiency.

In addition, in the idle stop mode (i.e., where the operation of the fuel cell stack is stopped), when the power of the battery is insufficient in the conventional heating system, the fuel cell stack may be operated to charge the battery and, at the same time, the electric heater may be driven by the power of the fuel cell stack. Thus, the waste heat of the coolant can be used to heat the interior of the vehicle by the heater core, even while the temperature of the fuel cell stack is increased to a normal operating temperature, thereby maximizing the energy utilization.

Additionally, in the heating system according to the present invention, the insufficient amount of heat is covered by the waste heat of the coolant (i.e., the waste heat of the fuel cell stack, in other words, the fuel cell stack is used as the heating source) using the heater core, and thus the capacity and size of the electric heater can be reduced.

Moreover, the safety risk due to the high pressure conditions required for the conventional heat pump system and the high voltage conditions required for the conventional high capacity electric heater can be reduced as well.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A heating system for a fuel cell vehicle, the heating system comprising:
an electric heater for heating air blown by a blower fan and supplied to an interior of a vehicle; and
a heater core provided in a coolant line, through which coolant for cooling a fuel cell stack is circulated, and used for heating the air, blown by the blower fan and supplied to the interior of the vehicle, by heat transfer between the coolant and the air,
wherein the heater core is provided at the downstream side of the fuel cell stack in a coolant circulation path such that the air is heated by waste heat of the coolant discharged from the fuel cell stack.

2. The heating system of claim 1, wherein the heater core is provided at the upstream side of a demineralizer in the coolant circulation path such that the coolant, whose heat is transferred to the heater core, passes through the demineralizer.

3. The heating system of claim 2, wherein the heater core and the demineralizer are provided in a main coolant line between the fuel cell stack and a three-way valve.

4. The heating system of claim 1, wherein the heater core is provided at the downstream side of a coolant pump and a cathode oxygen depletion (COD) such that the coolant sequentially passing through the coolant pump and the COD passes through the heater core.

5. The heating system of claim 4, further comprising a bypass line branched from the main coolant line between the upstream and downstream sides of the coolant pump and the COD, wherein the heater core and the demineralizer are provided in the bypass line connected between the upstream and downstream sides.

6. The heating system of claim 4, further comprising a coolant line, in which a radiator is provided, and a bypass line, provided such that the coolant does not pass through the radiator, the coolant line and the bypass line being branched from an outlet side of the COD such that the coolant passing through the coolant pump and the COD passes through the heater core, without going through the radiator.

7. The heating system of claim 1, wherein the electric heater and the heater core are arranged adjacent to each other in an air-conditioning duct, to which the air suctioned during operation of the blower fan is supplied, and a damper door for selectively preventing the suctioned air from flowing into the heater core is provided in front of the heater core such that only the electric heater is used alone.

8. The heating system of claim 2, wherein the heater core and the demineralizer are provided or in a bypass line branched from the main coolant line between the fuel cell stack and a three-way valve.

9. A method for heating an interior of a fuel cell vehicle, the method comprising:
blowing air, by a fan, through a duct for supplying air to an interior of a vehicle, wherein a heater core and an electric heater are disposed within the duct;
detecting the interior temperature of the vehicle is lower than a first predetermined temperature;
checking the state of charge of a battery in the fuel cell vehicle;
in response to the state of charge of the battery being lower than a predetermined limit, initiating operation of a fuel cell stack and powering the electric heater with the fuel cell stack;
detecting the temperature of coolant in a coolant line for cooling the fuel cell stack running through the heater core; and
in response detecting a coolant temperature running through the heater core is above a second predetermined temperature, controlling the heater core to be used in combination with the electric heater to heat the air being blown through the duct and passing into the interior of the vehicle.

10. The method of claim 9, further comprising in response to the state of charge of the battery being above a predetermined limit, operating just the electric heater and not the heater core via the battery until the state of charge the battery falls below the predetermined limit

11. The method of claim 9, wherein in response to the state of charge of the battery being lower than a predetermined limit, the method further comprises operating a cathode oxygen depletion (COD) to increase the temperature of the coolant in the coolant line.

12. The method of claim 9 wherein just the electric heater is operated by the fuel cell stack in response to the temperature of the coolant for cooling the fuel cell stack being below the second predetermined temperature.

13. The method of claim 9, the method further comprising: in response to detecting that the temperature of the coolant for cooling the fuel cell stack is above a third predetermined temperature, powering off the electric heater and using just the heater core to heat the air being blown through the duct.

14. The method of claim 13, wherein when just the heater core is being used to heat the air is blown through the duct, the method further comprises controlling a pump and a valve based on the detected coolant temperature, an interior temperature of the vehicle, and the heater core to control the amount of heat supplied by the heater core to the air being blown through the duct.
